(19) United States
(12) Patent Application Publication
(10) Pub. No.: US 2023/0343974 A1
(43) Pub. Date: Oct. 26, 2023

(54) SOLID OXIDE FUEL CELL DEVICE AND FUEL CELL VEHICLE

(71) Applicants: AUDI AG, Ingolstadt (DE); VOLKSWAGEN AG, Wolfsburg (DE)

(72) Inventor: Christian LUCAS, Braunschweig (DE)

(21) Appl. No.: 18/005,039

(22) PCT Filed: Aug. 18, 2021
(86) PCT No.: PCT/EP2021/072922

§ 371 Date: Jan. 10, 2023

(30) Foreign Application Priority Data
Aug. 24, 2020 (DE) 10 2020 122 082.0

(51) Int. Cl. H01M 8/04014; H01M 8/04089; H01M 8/12; H01M 8/04119

(52) U.S. Cl. CPC H01M 8/04014; H01M 8/04097; H01M 8/12; H01M 8/04164; H01M 2008/1293; H01M 2250/20

(57) ABSTRACT

A solid oxide fuel cell device comprises at least one solid oxide fuel cell comprising a cathode, an anode, and a solid electrolyte layer separating the cathode from the anode, in which the anode is fluidically connected to an anode supply line for the supply of fuel and an anode exhaust gas line for taking away the anode exhaust gas, and in which the cathode is connected to a cathode gas supply, wherein the anode exhaust gas line is fluidically connected to a storage line for the storing of carbon dioxide from the anode exhaust gas in a tank, in which there is connected at least one stage of a compressor for the compressing of the anode exhaust gas and one heat exchanger, downstream from the compressor, for the cooling of the anode exhaust gas compressed by the compressor. Downstream from the heat exchanger of the stage, a recirculation line branches off, emptying once again in the storage line upstream from the compressor, while an expansion valve is associated with the recirculation line for the expanding of the exhaust gas. A fuel cell vehicle having such a fuel cell device is also provided.

### BACKGROUND

### Technical Field

Embodiments of the invention relate to a solid oxide fuel cell device having at least one solid oxide fuel cell comprising a cathode, an anode, and a solid electrolyte layer separating the cathode from the anode. Embodiments of the invention furthermore relate to a fuel cell vehicle having such a fuel cell device.

### Description of the Related Art

Fuel cells serve for providing electric energy in a chemical reaction between a hydrogen-containing fuel and an oxygen-containing oxidizing agent, generally air. In a solid oxide fuel cell (SOFC) there is an electrolyte layer of a solid material, giving the cell its name, such as ceramic yttrium-doped zirconium dioxide, which is capable of conducting oxygen atoms, while electrons are not conducted. The electrolyte layer is contained between two electrode layers, namely, the cathode layer, to which air is supplied, and the anode layer, which is supplied with the fuel, which can be formed by H₂, CO, CH₄, or similar hydrocarbons. If air is led through the cathode layer to the electrolyte layer, the oxygen takes up two electrons and the resulting oxygen ions O²⁻ move through the electrolyte layer to the anode layer, where the oxygen ions react with the fuel to form water and CO₂. At the cathode side, the following reaction occurs: ½O₂+2^{e-}→2O²⁻ (reduction/electron uptake). At the anode, the following reactions occur: H₂+O²⁻→H₂O+2^{e-} and CO+O²⁻→CO₂+2^{e-} (oxidation/electron surrender). A solid oxide fuel cell need not be planar in shape, but rather it can be configured as a tube; there is also the possibility of assembling multiple fuel cells in a fuel cell stack in order to boost the power.

Solid oxide fuel cells require high temperatures over 700° C., at which they are operated, so that the use of the term high-temperature fuel cell is also customary. The high temperature required for an adequate conductivity of the electrolyte layer means that a heating is required during starting, and the temperature achieved during operation must be maintained.

In order to achieve a high efficiency, it is advantageous for the degree of conversion, i.e., the consumption of the fuel supplied, to be as high as possible, in order to minimize the residual quantity of fuel in the exhaust gas. However, it is a problem that unequal distributions occur for a degree of conversion of 1, that is, a total consumption of the fuel supplied, and some fuel cells of a fuel cell stack will be undersupplied, resulting in damaging of the affected fuel cell. Therefore, a limiting of the degree of conversion is required for a safe, stable and efficient operation.

It is known from the documents CN 103 206 307 A and CN 104 538 658 A how to store the product CO₂ during the solid oxide fuel cell reaction in a tank. A solid oxide fuel cell device of the kind mentioned above will be found in WO 2012 135 447 A1, in which the anode exhaust gas is significantly cooled down in order to reduce the water content and water is condensed out in this way. This may be required in order to protect any compressor systems present for storage of a large quantity of carbon dioxide against damage.

### BRIEF SUMMARY

Some embodiments relate to a solid oxide fuel cell device having at least one solid oxide fuel cell comprising a cathode, an anode, and a solid electrolyte layer separating the cathode from the anode. The anode may be fluidically connected to an anode supply line for the supply of fuel and an anode exhaust gas line for taking away the anode exhaust gas. The cathode may be connected to a cathode gas supply. The anode exhaust gas line may be fluidically connected to a storage line for the storing of carbon dioxide from the anode exhaust gas in a tank, there being connected in the storage line at least one stage of a compressor for the compressing of the anode exhaust gas and one heat exchanger, downstream from the compressor, for the cooling of the anode exhaust gas compressed by the compressor.

Some embodiments provide a solid oxide fuel cell device with which the fraction of H₂O can be reduced so drastically that compressor systems do not suffer any damage and at the same time a large quantity of carbon dioxide can be stored in the tank. Furthermore, some embodiments provide a fuel cell vehicle which is outfitted with such an improved solid oxide fuel cell device.

The solid oxide fuel cell device in some embodiments is characterized in particular in that downstream from the heat exchanger of the stage a recirculation line branches off, emptying once again in the storage line upstream from the compressor, and an expansion valve is associated with the or incorporated in the recirculation line for the expanding of the exhaust gas. In this way, it is possible to expand the anode exhaust gas compressed by a compressor and cooled down by a following heat exchanger, so that it is further cooled. In this way, a cooling of the anode exhaust gas can be achieved, so that the gas mixture is brought below the vapor pressure for water, thereby being condensed and preventing any damage to one or more compressor stages.

In this regard, it may be advantageous for a water separator to be incorporated in the storage line, being situated prior to the at least one stage. In this way, in fact, the condensed water can be collected in the water separator, so that the gas mixture, reduced in H₂O, can be taken once more to the compressor and the following heat exchanger. Thus, it has a higher degree of purity in CO₂ and therefore results in less risk of damaging a compressor.

In order to accomplish a better compression of the anode exhaust gas, it may be advantageous for there to be present in the storage line a cascade of multiple stages of a compressor and a heat exchanger downstream from the compressor, and for the recirculation line to branch off downstream from the heat exchanger of a first stage and upstream from the compressor of a second stage coming after the first stage. Thus, the tapping and returning of the anode exhaust gas will occur at an advantageous place of the cascade. Thanks to the expansion valve, it is then cooled down more significantly, in particular below the ambient temperature, so that water can condense out. The site chosen for the branching off from the storage line will be dictated by the system conditions.

There may also be at least two branches to the recirculation line, since in this way there can occur a return or recirculation and expansion by the expansion valve at two different places of the cascade. Namely, it may happen that a sufficient compression is present already at certain ambient temperatures already after an “earlier” stage in the cascade, which can be relaxed once more by the expansion, so that the anode exhaust gas can be lowered below the vapor pressure for water. There can also be present more than two tapping points or branching points, since the number and location of the branches is dependent on the system layout and the prevailing operating conditions.

In this regard, it may be advantageous for each branch to be associated with its own expansion valve, which can be opened or closed by means of a suitable control device in order to accomplish a throttling of the anode exhaust gas in the recirculation line.

As an alternative to a direct injection of the expanded fluid, it may be advisable to take the fluid at first through a heat exchanger, and it may be advantageous for at least one heat exchanger to be incorporated in the recirculation line downstream from the expansion valve.

A further optimization can be achieved by the integration of another heat exchanger, which heats the anode exhaust gas downstream from the water separator and cools it upstream from the water separator. In this context, it may be advantageous for a heat exchanger to be interconnected between the water separator and the at least one stage, in which a line segment of the storage line situated downstream from the water separator stands in a heat-exchanging connection to a line segment of the storage line situated upstream from the water separator. This may also have the advantage that the fluid is even more saturated at the entrance of the compressor of the first stage.

A reliable separation and an operationally secure storage of CO₂ in the tank can be realized by the use of a purge valve. In this regard, it may be advantageous for a purge valve to be present for separating the storage line from the anode exhaust gas line, for the storage line to be led through a heat exchanger downstream from the purge valve and upstream from the at least one stage, and for the anode exhaust gas to be brought into a heat-exchanging connection with a cathode supply line. In this way, heat can be removed from the exhaust gas and transferred to the fresh cathode gas, so that reliable operating temperatures can be achieved inside the solid oxide fuel cell.

In order to realize the highest possible degree of conversion of the fuel, it may be advantageous for the anode exhaust gas line to empty into the anode supply line upstream from the solid oxide fuel cell for the recirculation of unused fuel.

For a fuel cell vehicle having such a solid oxide fuel cell device the aforementioned benefits and effects apply accordingly; in particular, there is an improved energy utilization and an improved protection of the components, such as the compressor stages.

The features and combinations of features mentioned above in the description and the features and combinations of features mentioned below in the description of the figures and/or shown solely in the figures can be used not only in the particular indicated combination, but also in other combinations or standing alone. Thus, embodiments which are not shown explicitly or explained in the figures, yet which can be created and emerge from separated combinations of features from the explained embodiments should be viewed as also being disclosed and encompassed by the present disclosure.

### BRIEF DESCRIPTION OF THE SEVERAL VIEWS OF THE DRAWINGS

Further benefits, features and details will emerge from the claims, the following description of embodiments, and the drawings.

FIG. 1 shows a schematic representation of a first solid oxide fuel cell device.

FIG. 2 shows a schematic representation of a second solid oxide fuel cell device.

FIG. 3 shows a schematic representation of a third solid oxide fuel cell device.

FIG. 4 shows a schematic representation of a fourth solid oxide fuel cell device.

### DETAILED DESCRIPTION

In the figures, a portion of a solid oxide fuel cell device 1 is shown, in the present instance having a fuel cell stack with a plurality of solid oxide fuel cells 2, each of the solid oxide fuel cells 2 comprising a cathode, an anode, and a solid electrolyte layer (such as one in the form of a ceramic) separating the cathode from the anode. The fuel cell stack can also be formed as tubes, the anode layer being arranged on an inner side, so that the fuel provided in a fuel tank 23, such as CH₄, is led through the tubes. In order to dispense the fuel from the fuel tank 23, a pressure regulating valve 24 is incorporated in an anode supply line 3, the fuel being taken at first through a reformer 22 before it is supplied to the solid oxide fuel cell 2, such as to its anode. The anode spaces of the solid oxide fuel cell 2 are connected downstream to an anode exhaust gas line 4, which empties upstream from the solid oxide fuel cell 2 once again in the anode supply line 3, so that in this way unused fuel can be supplied again to the solid oxide fuel cell 2 at the anode. For the recirculation of the anode gas, a recirculation fan 21 is incorporated in the anode exhaust gas line 4 in the present case. Furthermore, the solid oxide fuel cell 2 is connected to a cathode gas supply 5, while a compressor 29 delivers ambient air to a cathode supply line 20, leading through a first heat exchanger 19 and a second heat exchanger 27 before it arrives at the solid oxide fuel cell 2. The cathode is moreover connected to a cathode exhaust gas line 28, in order to take away the cathode exhaust gas, the cathode exhaust gas line 28 being likewise led through the second heat exchanger 27. In the latter, the cathode exhaust gas line 28 stands in a heat-exchanging connection with the cathode supply line 20, in order to precondition the cathode fresh gas flowing therein before it is taken to the solid oxide fuel cell 2.

In order to store carbon dioxide in a tank 6, the anode exhaust gas line 4 is fluidically connected to a storage line 7, in which a cascade 14 of multiple stages 10 is incorporated in the present case. Each stage 10 comprises a compressor 8, as well as a heat exchanger 9 placed after the compressor 8. The anode exhaust gas during each stage 10 is compressed by the compressor 8 and then cooled by the heat exchanger 9. In this way, the anode exhaust gas can be collected in the compressed state in the tank 6, which is designed as a high-pressure storage.

In order to channel the anode exhaust gas selectively out from the anode circuit, such as the anode exhaust gas line 4, a purge valve 18 is incorporated in the storage line 7 in the present case. The storage line 7 in the present case runs through the heat exchanger 19, the anode exhaust gas being brought into a heat-exchanging connection with the fresh exhaust gas. The storage line 7 then runs through another heat exchanger 26, with which the anode exhaust gas is further cooled down. The storage line 7 then empties into a water separator 13, which is designed to separate H₂O from the anode exhaust gas and possibly channel it out from the system already before the anode exhaust gas arrives at the first stage 10.

Thus, in each stage 10, the anode exhaust gas is compressed by the compressor 8 and cooled by the heat exchanger 9. In some embodiments, a branching 15 is associated with the heat exchanger 9 of one of the stages 10 in the present case, leading to a recirculation line 11. An expansion valve 12 or a throttle is incorporated in this recirculation line 11, so that a storage and condenser system is created by the stages 10 together with the expansion valve 12 in the recirculation line 11, with which it is possible to lower the vapor pressure of the anode exhaust gas so much that H₂O in the anode exhaust gas condenses, such as because it is cooled down below the ambient temperature. The condensed water can then be collected in the water separator 13 and channeled out from the system.

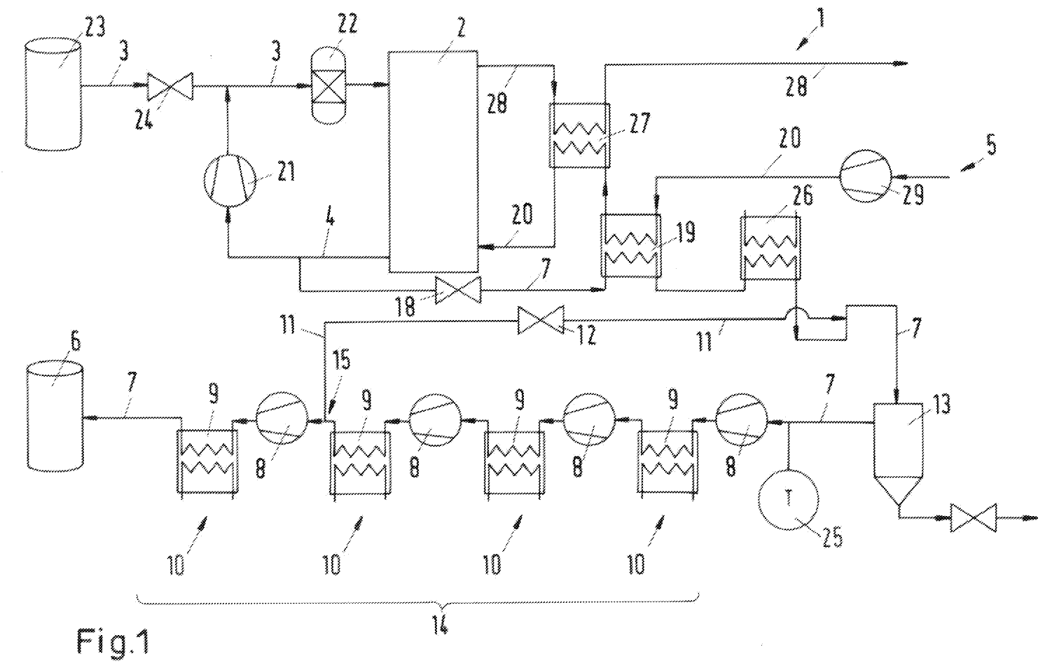

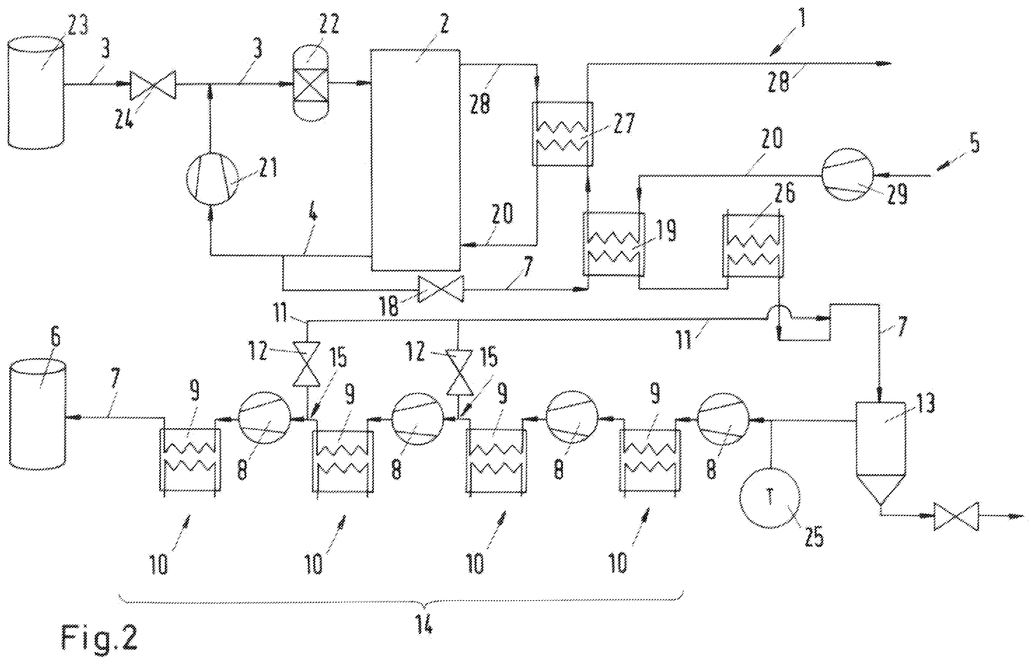

While there is only a single branching 15 in FIG. 1, FIG. 2 illustrates the possibility of having multiple branching points 15, the position of which is established in dependence on the ambient conditions and in dependence on the chosen system. It is possible to open (partly) only one of the expansion valves 12 or also to open multiple expansion valves 12 at the same time. In many situations, in fact, it is not necessary for the anode gas to have gone through all the stages 10 before it is again throttled by the expansion valve 12 and thereby cooled down in order to condense out the water.

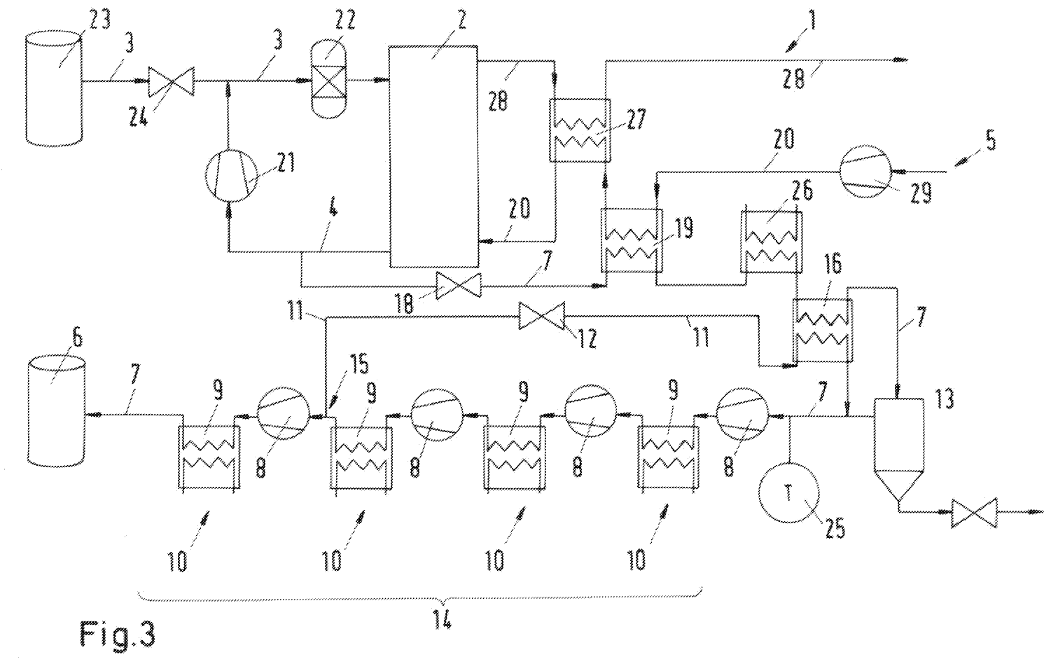

FIG. 3 shows the possibility of incorporating a heat exchanger 16 in the recirculation line 11 downstream from the expansion valve 12, by which the storage line 7 is placed in a heat-exchanging connection with the recirculation line 11, in order to precool the anode exhaust gas already upstream from the water separator 13 by the mixture flowing in the recirculation line 11. In this way, a larger quantity of H₂O is separated in the water separator 13. The recirculation line 11 itself then empties once more into the storage line 7 downstream from the water separator 13.

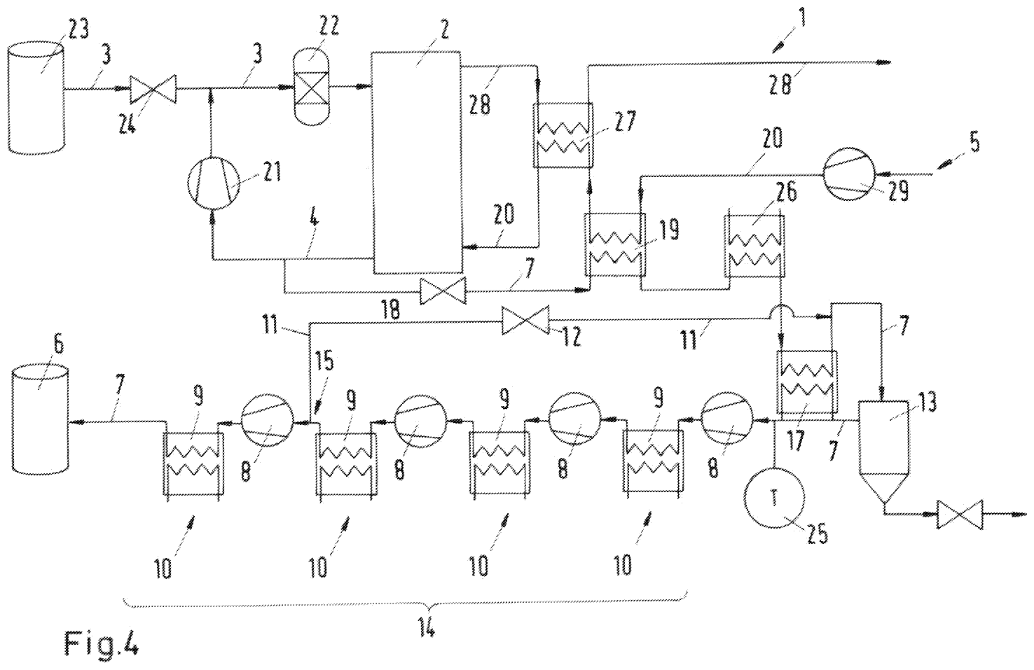

In FIG. 4 there is present yet another heat exchanger 17, which is connected in between the water separator 13 and the at least one stage 10, such as the very first stage 10. In this heat exchanger 17, a line segment of the storage line 7 running downstream from the water separator 13 is in a heat-exchanging connection with a line segment of the storage line 7 running upstream from the water separator 13. In this way, the anode exhaust gas is thus heated after the water separator 13 and cooled upstream from it. This may have the advantage that the fluid at the entrance of the compressor 8 of the first stage 10 is subjected to an increased saturation.

In order to assess how much the anode exhaust gas needs to be cooled down, it may be advantageous for a temperature sensor 25 to be incorporated furthermore in the storage line 7, so that one can assess how much of a temperature difference from ambient temperature of the solid oxide fuel cell device 1 or the fuel cell vehicle encompassing it needs to be overcome in order to achieve a sufficient condensation of liquid water.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A solid oxide fuel cell device, comprising:
at least one solid oxide fuel cell comprising a cathode, an anode, and a solid electrolyte layer separating the cathode from the anode, in which the anode is fluidically connected to an anode supply line for the supply of fuel and an anode exhaust gas line for taking away the anode exhaust gas, and in which the cathode is connected to a cathode gas supply,
wherein the anode exhaust gas line is fluidically connected to a storage line for the storing of carbon dioxide from the anode exhaust gas in a tank, in which there is connected at least one stage of a compressor for compressing of the anode exhaust gas and one heat exchanger, downstream from the compressor, for cooling of the anode exhaust gas compressed by the compressor, and
wherein, downstream from the heat exchanger of the stage a recirculation line branches off, emptying once again in the storage line upstream from the compressor, and an expansion valve is associated with the recirculation line for the expanding of the exhaust gas.

2. The solid oxide fuel cell device according to claim 1, wherein a water separator is incorporated in the storage line, being situated prior to the at least one stage.

3. The solid oxide fuel cell device according to claim 1, wherein there is present in the storage line a cascade of multiple stages of a compressor and a heat exchanger downstream from the compressor, and the recirculation line branches off downstream from the heat exchanger of a first stage and upstream from the compressor of a second stage coming after the first stage.

4. The solid oxide fuel cell device according to claim 3, wherein there are at least two branches to the recirculation line.

5. The solid oxide fuel cell device according to claim 4, wherein each of the branches to the recirculation line is associated with an expansion valve.

6. The solid oxide fuel cell device according to claim 1, wherein at least one heat exchanger is incorporated in the recirculation line downstream from the expansion valve.

7. The solid oxide fuel cell device according to claim 2, wherein a heat exchanger is interconnected between the water separator and the at least one stage, in which a line segment of the storage line situated downstream from the water separator stands in a heat-exchanging connection to a line segment of the storage line situated upstream from the water separator.

8. The solid oxide fuel cell device according to claim 1, wherein a purge valve is present for separating the storage line from the anode exhaust gas line, and the storage line is led through a heat exchanger downstream from the purge valve and upstream from the at least one stage such that the anode exhaust gas is brought into a heat-exchanging connection with a cathode supply line.

9. The solid oxide fuel cell device according to claim 1, wherein the anode exhaust gas line empties into the anode supply line upstream from the solid oxide fuel cell for the recirculation of unused fuel.

10. A fuel cell vehicle having a solid oxide fuel cell device according to claim 1.
